(19) United States
(12) Patent Application Publication
(10) Pub. No.: US 2008/0141598 A1
(43) Pub. Date: Jun. 19, 2008

(54) Framed Opening Bracing System

(76) Inventor: Charlie E. Cook, Gilbert, SC (US)

Correspondence Address: CALHOUN "REB" THOMAS, III, 1201 MAIN STREET, SUITE 1750, COLUMBIA, SC, 29201, US

(21) Appl. No.: 11/612,615

(22) Filed: Dec. 19, 2006

(51) Int. Cl. E04G 21/12; E04C 5/12; E04H 12/24; F16B 7/06; E04G 21/26

(52) U.S. Cl. 52/127.2; 52/151; 52/657; 403/46; 248/351

(57) ABSTRACT

The invention is a framed opening bracing system. The invention features frame bracing devices which attach to the framed opening and to the flooring or other surface of a construction job site. The devices attach to the frame via a versatile clamp unit or a corner support unit and extend to the floor via bracing arms. The corner support unit attaches via pressure applied at an angle to the frames corner and the versatile clamp unit attaches via pressure applied to the facings of the frame. The arms feature two levels of adjustment, a relative distance adjustment and a fine tune distance adjustment, which can be manipulated to set a framed opening to plumb and to keep the frame securely in place during wall construction.

### RELATED APPLICATIONS

Not applicable.

### FEDERALLY SPONSORED RESEARCH OR DEVELOPMENT

Not applicable.

### REFERENCED OR INCORPORATED MATERIAL

Not applicable.

### BACKGROUND OF INVENTION

The present invention is related to the field of construction and specifically to framed openings necessary in masonry construction such as windows and doors which are integral to masonry walls. Particularly, the invention is directed to a device used to brace such framed openings in masonry wall construction.

In the art of masonry wall construction, it is quite common, especially in commercial applications, for any openings necessary in the walls to be framed-in prior to the construction of the wall. As such, contractors erect door and window frames by utilizing temporary bracing outside the plane of the wall, and then erect the masonry wall block by block around the frame. Therefore, the frames are put into place before the walls are built.

During the wall construction, it is extremely important that the opening frame be kept secure and in-place. This security is necessary because even the slightest movement of the frame could bring the frame out of plumb. Moreover, if the frame is out of plumb once the masonry has set, the windows or doors will not install or function properly and the frame cannot be readjusted without rather extreme measures.

The traditional method for securing masonry wall frame openings during wall constructions has been to custom craft brace supports on site out of construction lumber or other materials present on the job site for each individual application. Basically, contractors take wood from other areas of the construction site and nail the wood to the flooring and further secure the wood to the frame. Once the frame is set and the wall is completed, the wooden bracing is discarded.

Thus, this traditional method of brace construction is very wasteful in terms of time, money, and materials because the contractor spends time and money purchasing the wood, custom crafts the supports to fit the particular opening, and then discards the wood after each frame and wall has been completed. This waste has negative effects on the contractors' bottom line as well as on the Earth's environment.

Several alternate systems of door frame supports that vary from the traditional mode have been created. One such alternate system is that disclosed in U.S. Pat. No. 5,704,171 to Ruff et al. Ruff discloses a door frame fixturing and bracing apparatus that relies on a rigid fixturing frame and bracing legs. The rigid frame of the Ruff invention is bulky and difficult to transport. It is expensive to make and use relative to the traditional methods and it is difficult to teach unskilled workers how to use properly. Importantly, the Ruff invention is attached to the door frame with screws which further complicate the process. Because of the screws and the rigidity, the invention only works with a single sized door which severely limits jobsite utilization. Accordingly, the Ruff invention will not work with smaller sized openings such as vents or windows. Moreover, the “legs” of the Ruff invention still must be fabricated out of “annular conduit . . . found in most commercial settings and on job sites” in order for the invention to function properly. And, once these legs are constructed, they are limited as to support placement because of their relationship to the rigid frame.

A second alternate system claiming to be an improvement on Ruff is disclosed by U.S. Pat. No. 6,233,901 to Kurfees. Kurfees discloses a kit for supporting a door frame which utilizes inter-jam foam supports and associated perpendicular support braces. The kit is rather bulky and while installed makes movement through the doorway impossible because the foam blocks span the width of the door. Also, the kit of Kurfees is not designed to adjust and adapt to many different sizes of door frames and other openings such as framed vents. Similarly, it is not suited to be used with windows as glass would prevent the attachment of the clamping mechanism. By design, the kit of Kurfees mandates that the support braces be perpendicular to the wall which limits arrangement of the braces relative to particular construction environments. Kurfees also lacks the ability to easily fine tune the lengths of the support braces and to easily fine tune the width of the clamping “holder” mechanism. Importantly, the clamping or “holder” mechanism of Kurfees is not designed to accommodate the great varieties of door jam depths that occur in a construction environment. The width of the J hook portion of either end of the holder is inherently limited such that, though the length may be adjusted, its width cannot accommodate varying depths of door jams.

Therefore, there exists in the art a need for an improved door frame support system that is versatile enough to be used with a variety of framed openings including doors, vents, and windows, is lightweight enough to be transported from jobsite to jobsite, is durable enough to withstand repeated use, is compact and versatile enough to function in a variety of environments, and is fine tunable enough so as to incrementally adjust to particular and varied bracing requirements.

### SUMMARY OF THE INVENTION

In light of the prior art, the present invention answers a long felt need in the art by providing an improved framed opening bracing device that is versatile, compact, lightweight, durable, fine tunable, and economical.

A principle element of the present invention relates to its versatility. The invention is designed to be used and reused ad infinitum on numerous job sites and for numerous types and sizes of framed openings. It can be used to support door frames with wide or narrow, tall or short wall openings. It is designed to adjust to door frames having wide door jams as well as those with small door jams. Similarly, it is not limited by those door jams that are extra deep in their encasement of the abutting walls.

Importantly, the invention is not limited to doors and fully functions to support any framed opening such as a vent or window placed anywhere on a wall. The invention also is designed to function during the instillation of windows which have glass already installed by utilizing a corner braced support unit.

Related to its versatility is the invention's compact, minimalist size concept. Rather than utilizing bulky rigid frames or cumbersome blocks, the present invention accomplishes framed opening stability bracing through secured angled supports. Some jobs may require only a single brace and others may require multiple braces. Thus, the contractor is not pigeon holed into a single rigid design but can use as many of the independent supports as necessary. Importantly, these supports do not block the opening even when multiple supports are utilized in order to secure a particular frame. For instance, supports can be attached to the top of the frame or the sides while the central opening remains relatively free and open for light, air, and objects to pass. A double door opening may require even more support which is accommodated under the present invention by applying additional copies of the device with various attachment points as necessary.

Another feature of the invention that adds to its versatility is its lightweight. The invention is designed to be lightweight so that it can be easily transported from opening to opening and from jobsite to jobsite. Moreover, multiple copies of the invention may be easily carried by a single worker as required for a particular job.

The invention is also designed to be extremely durable such that it can easily withstand the harsh conditions of a commercial construction environment. As a typical construction environment can be exposed to the natural elements as well as to mechanical elements of the construction process, the invention is designed to be constructed of resilient material such as steel. Moreover, there are very few moving parts such that the device withstands typical abuses. Finally, there are no small removable parts to be lost in the dynamic construction environment.

Yet another important feature of the present invention relates to its fine tune adjustment elements. In addition to features which allow for adjustments of the device on a larger scale relative to various sizes of framed openings, the device also includes fine tune adjustments which allow the contractor to refine the degree and placement of the independent supports in order insure that a given framed opening is properly set and plumb. For instance, once the support is anchored to the flooring and the support is provisionally attached to the framed opening, the support may yet be further micrometerly adjusted to affect proper framed opening alignment.

Because of many of the above features, the design of the present invention is quite cost effective. No longer must wasteful traditional wooden supports be constructed and then deconstructed for each framed opening because the present invention is completely reusable. Moreover, the simplicity lowers the learning curve for installation that is applicable to many different types and sizes of framed openings.

### BRIEF DESCRIPTION OF THE SEVERAL VIEWS OF THE DRAWINGS

FIG. 1 is a perspective view of a door frame being supported by the framed opening bracing system with one brace utilizing the corner unit means of frame attachment and one brace utilizing the versatile clamp means of frame attachment.

FIG. 2 is a perspective view of a door frame being supported by the framed opening bracing system and highlighting the use of the versatile clamp means of frame attachment.

FIG. 3 is a side view of a door frame being supported by the framed opening bracing system and highlighting the use of nails to secure the fixable base.

FIG. 3A is a side view of a door frame being supported by the framed opening bracing system and highlighting the use of a cement block to secure the fixable base.

FIG. 4 is a perspective view of a door frame being supported by the framed opening bracing system and highlighting the use of the corner unit means of frame attachment.

FIG. 5 is a perspective view highlighting the corner unit means of frame attachment and the fine tune micro-adjustment means of the support arm.

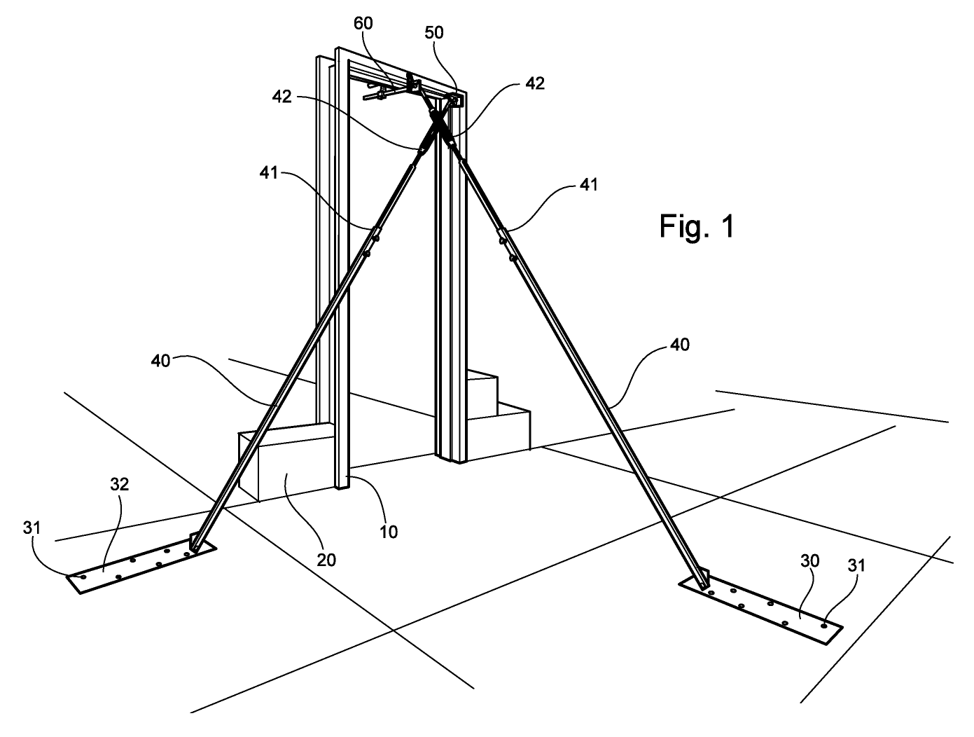

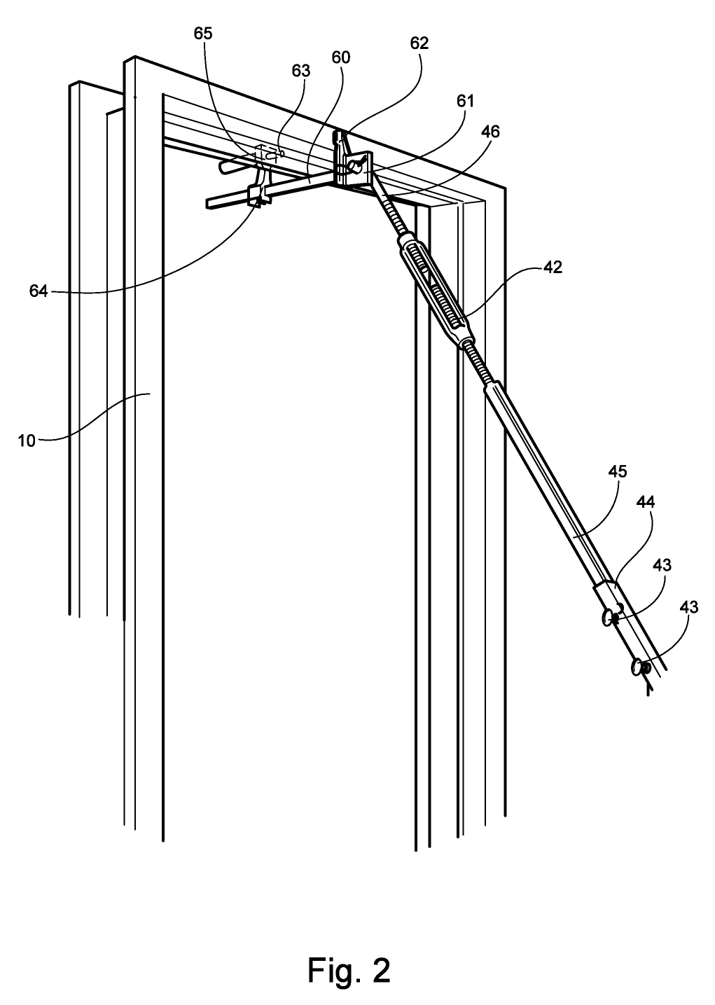

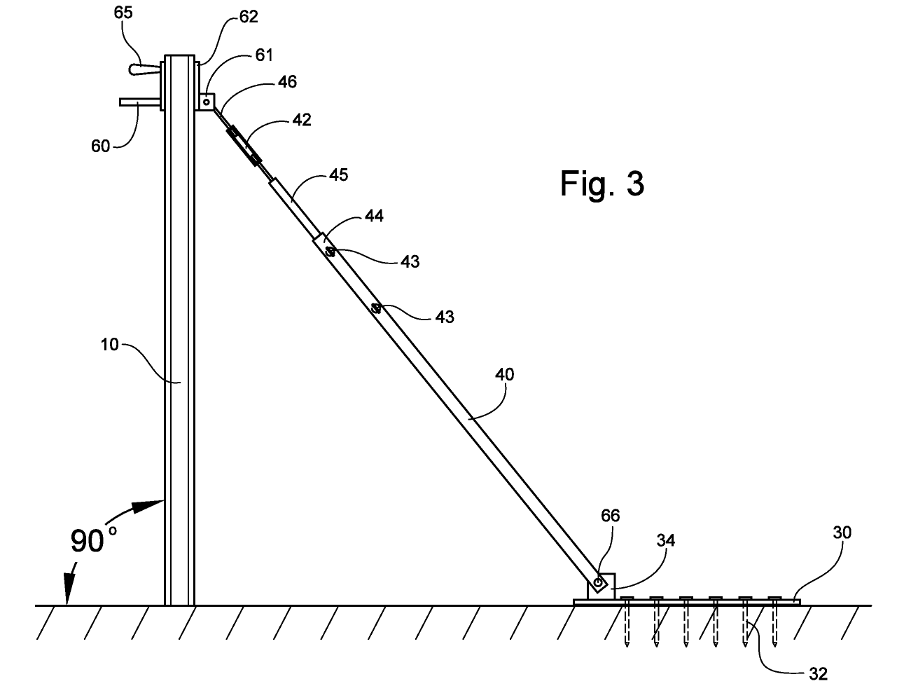

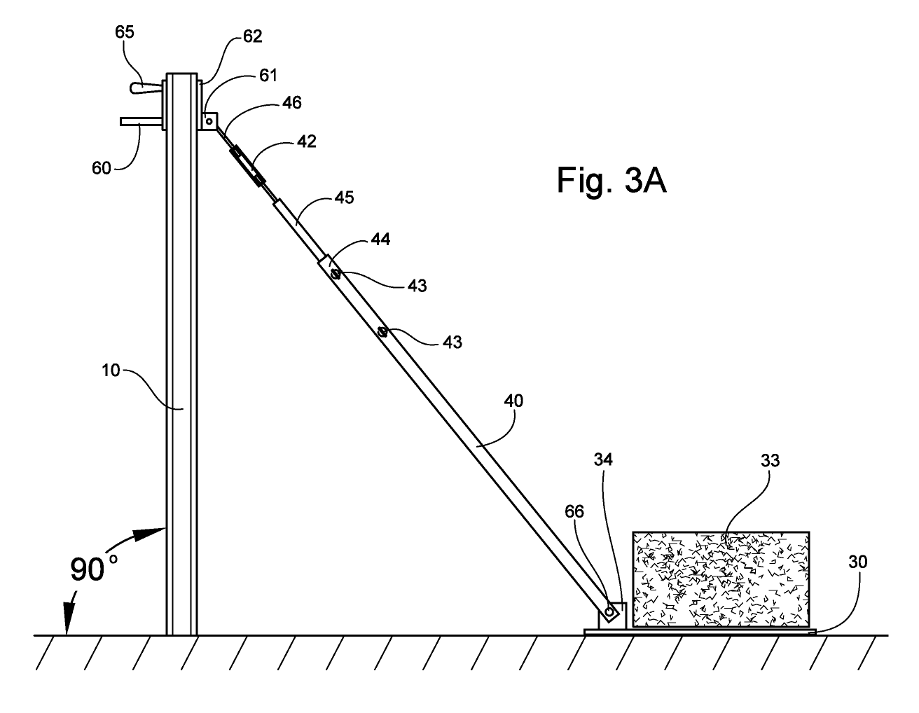

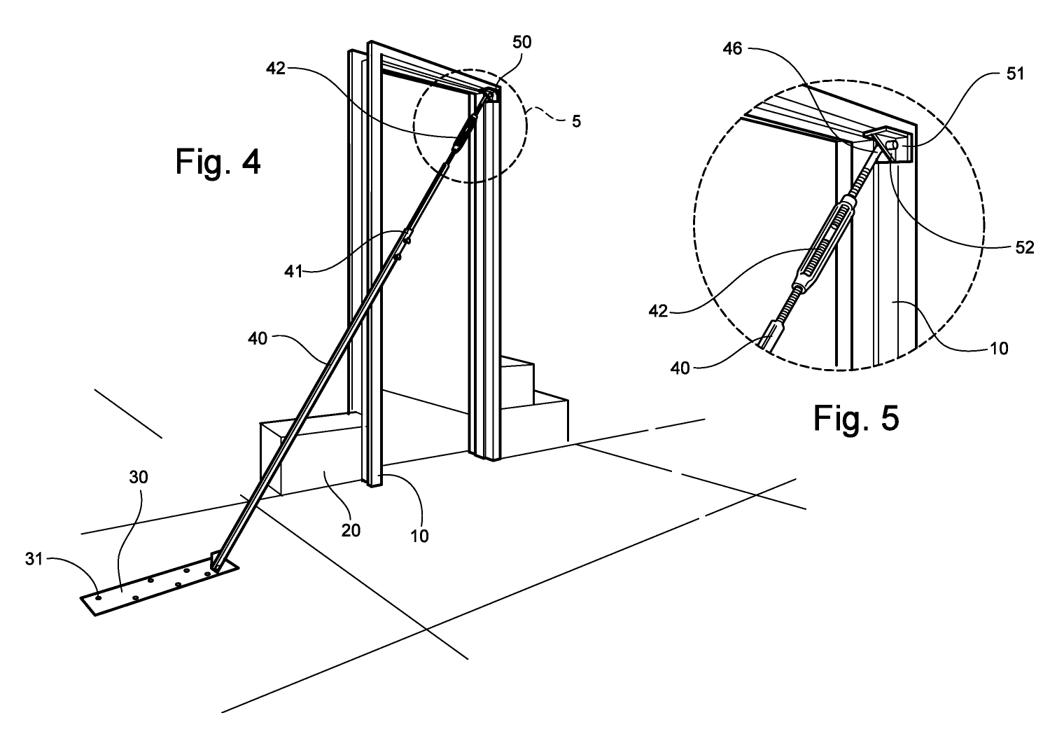

### DETAILED DESCRIPTION

It is to be understood by a person having ordinary skill in the art that the present discussion is a description of exemplary embodiments only, and is not intended as limiting the broader aspects of the present invention. The following example is provided to further illustrate the invention and is not to be construed to unduly limit the scope of the invention.

The present invention is a framed opening bracing system that utilizes one or more bracing arm devices to secure the frame during construction. The device of the present invention comprises a frame attachment means, a support arm (40), and a fixable base (30). The frame attachment means further consists of either a versatile clamp (60) or a corner support unit (50).

The versatile clamp (60) secures the bracing arm device to the frame (10). It is pivotally connected to the support arm (40) and temporarily attaches to the frame (10) by means of compression applied to the facial surfaces of the frame (10). This attachment to the frame (10) is designed to be nondestructive, to not mar the finish of the frame, and to not compromise the structural integrity of the frame. Moreover, the versatile clamp (60) can be applied and positioned at any point along the perimeter of the frame (10) as necessitated by the construction environment or preferred by the contractor.

The versatile clamp (60) further comprises a pivotal connection member (61), a fixed stop (62), a pressure pad (63), a relative pressure adjustment means 64), and a fine tune pressure adjustment means (65). The pivotal connection member (61) is the point of attachment to the support arm (40). It allows for the angled articulation of the support arm (40) relative to the versatile clamp (60) affixed to the frame (10). In one embodiment, this member comprises a cylindrical cavity which accepts a cylinder and pin type connection from the support arm (40).

The pivotal connection member (61) is fixedly connected to the fixed stop (62). The fixed stop (62) is one of two points of contact with the framed opening (10). The fixed stop (62) is designed to be reciprocal to the pressure pad (63) which, when utilized, is located on the opposite facing of the framed opening (10).

The relative pressure adjustment means (64) is connected to the fixed stop (62) and is designed to allow the contractor to relatively adjust the distance between the fixed stop (62) and its reciprocal pressure pad (63). In one embodiment, the relative pressure adjustment means (64) is a lockable sliding bar wherein the connected fine tune adjustment (65) and pressure pad (63) traverses the length of the bar by sliding as desired by the contractor. When the proper relative width is reach, the contractor locks the pad (63) in place and then adjusts the fine tune pressure adjustment means (65).

The fine tune pressure adjustment means (65) is connected to the relative pressure adjustment means (64) and is designed to operate once the relative pressure adjustment means (64) has been locked in place by the contractor. The fine tune pressure adjustment means (65) is designed to allow for adjustment of the pressure applied to the frame on a micro scale with respect to the relative pressure adjustment means (64). In one embodiment, this means is realized through a threaded fitting that increases or decreases pressure when the contractor rotates a treaded member.

The pressure pad (63) is attached to the fine tune adjustment means (65) and is reciprocal to the fixed stop (62). In one embodiment, the pad (63) is pivotally attached to the fine tune adjustment means (65) so that it can pivot in order to better meet and contact the facing of the frame (10).

Thus, by first facilitating relative adjustment and then by facilitating fine tune pressure adjustment, the invention allows the contractor to set up the frame (10) and braces quickly in the desired angular position and then fine tune the pressure applied to the frame (10).

A second frame attachment means is the corner support unit (50). The corner support unit (50) is an additional means of attaching the support device to the framed opening (10). The corner support unit (50) comprises an angled bracket (51) and an angled pivotal connection member (52). The angled pivotal connection member (52) is the point of attachment to the support arm (40). It allows for the angled articulation of the support arm (40) relative to the angled bracket (51) pressed to the frame (10). In one embodiment, this angled pivotal connection member (52) comprises a cylindrical cavity which accepts a pin type connection from the support arm.

The angled bracket (51) of the corner support unit is designed to fit tightly in the corner joint of the frame (10). Thus, the angle of the unit (50) is matched to the angle of the corner of the frame (10). Typically, this corner is at a 90° angle though it could be many different angles and alternate embodiments of the support would correspond to the angle of the frame corner. Importantly, the corner unit (50) can be used where the versatile clamp frame attachment means (60) will not work such as with a window containing installed glass.

The support arm (40) is connected to the frame attachment means. The support arm is designed to bridge the distance between the floor and the frame (10) at a variable length as desired by the contractor for maximizing support relative to construction conditions. The support arm (40) further comprises a frame attachment connector member (46), a relative distance adjustment means (41), a fine tune micro-adjustment means (42), and a base connector member (66).

The frame attachment connector member (46) of the support arm (40) is the point of attachment to the pivotal connection member (61) of the frame attachment means. Being pivotally connected to the frame attachment means (60), it allows for the angled articulation of the support arm (40) relative to the versatile clamp (60) or corner support unit (50) affixed to the frame (10). In one embodiment, this member comprises a cylindrical stud which passes through the cylindrical cavity of the pivotal connection member (61) and is locked in place via a pin type connection.

The relative distance adjustment means (41) and the fine tune micro-adjustment means (42) are connected in series to the frame attachment connector member (46) and the base connector member (66). The relative distance adjustment means (41) is made of piping or tubing that is configured in a telescoping arrangement such that a smaller segment (45) fits just inside of a slightly larger segment (44). These segments fit together in a telescoping arrangement. There are numerous arrangements and alternatives for securing the pipe or tube fittings together but the preferred embodiment utilizes two set screws (43) per arm pair which can be loosened in order to adjust the relative length of the arm and tightened to set the relative length of the support arm (40). Moreover the piping or tubing can be circular or polygonal having rounded or flat faces. The preferred embodiment is rigid with angled flat faces such as shown in the drawings utilizing square tubing.

The fine tune micro-adjustment means (42) provides a means of adjusting the length of the support arm on a small scale. This allows the contractor to micrometerly change the length of the support arm (40) and consequentially the position of the frame (10) so as to place the frame (10) to plumb as desired. In the preferred embodiment, the fine tune micro-adjustment means (42) is achieved via a turnbuckle where in the contractor rotates the oppositely threaded shaft clockwise or counterclockwise to lengthen or shorten the support arm (40) as required.

The base connector (66) is the point of attachment to the fixable base (30). This connection allows the support arm (40) to pivot with respect to its angle with the floor. In one embodiment, the base connector (66) is a cylindrical stud that passes through a pin type connection with the fixable base (30).

The fixable base (30) is the point of attachment of the bracing arm device to the floor of the construction site. The fixable base (30) is designed to connect to many different types of flooring materials such as: wood, concrete, steel, ceramic, carbon-composite, polymeric, and earth. It comprises a flat plate member and a support arm connector (34). The support arm connector (34) is designed to pivotally connect to the support arm (40). In the preferred embodiment, the support arm connector (34) is a cylindrical cavity which accepts the connection of the of the support arm.

The flat plate member of the fixable base (30) further comprises a means of connecting the flat plate to the floor. The preferred embodiment of this floor connection means includes a plurality of holes (31) through which attachment implements may be inserted in order to attach the plate to the flooring. This attachment can be accomplished through the use of a variety of attachment implements including nails (32), stakes, and screws. Additionally, the plate is designed to be flat so that heavy objects, such as concrete blocks (33) associated with masonry construction (20), can be utilized as a floor connection via a downward force exerted on the flat plate member when the block (33) is placed on the fixable base (30). Additional embodiments include the use of such attachments as: suction cups, magnets, hook and loop fasteners, and adhesives.

The first step in applying the above devices to a construction project is to assess the framed opening to be supported. The contractor must decide in which directions the framed opening must be supported. For instance, if the frame is nailed to the floor, the door is likely to rotate about this lower sill or threshold axis and support would be required perpendicular to the plane of the door. Next, the contractor must take into account environmental factors such as flooring type and whether or not there exists additional elements to the frame such as glass installed in a window or pre-hung doors. Further, the contractor must take note as to whether or not grout is to be applied between the block and the frame cavity.

After assessing the frame to be supported, the contractor will select a combination of supports selected from the above devices that maximizes the framed opening support. For movement in the plane of the frame, the corner unit can be utilized with the support arm extending roughly parallel to the plane of the frame. For movement perpendicular to the plane of the frame, the versatile clamp version can be applied at an angle perpendicular to the frame of the door. Similarly, where there is some impediment to using the versatile clamp, the corner unit can be applied at an angle perpendicular to the frame. If grout is to be applied to the frame cavity, bracing can be applied in order to counter the bowing effect of the weight of the grout in the interstitial spaces via the versatile clamp. In such situations, the versatile clamp is applied to the side facing of the framed opening with the support arms angled roughly in the plane of the wall opposite the facing to which the versatile clamp is attached.

What is claimed is:

1. A framed opening bracing device comprising:
a support arm, said support arm further comprising a relative distance adjustment means and a fine tune micro-distance adjustment means each fixedly attached to the other in series;
a frame attachment means for attaching said framed opening bracing device to a framed opening, said frame attachment means pivotally and removably attached to said support arm; and
a fixable base pivotally and removably attached to said support arm, said fixable base further comprising a planar plate having a multitude of holes extending through the planar plate for securing the fixable base to a flooring substrate.

2. The framed opening bracing device of claim 1 wherein said frame attachment means is a versatile clamp and further comprises: a pivotal connection member; a relative pressure adjustment means fixedly attached to said pivotal connection member; a fixed stop attached to said relative pressure adjustment means; a fine tune pressure adjustment means attached to said relative pressure adjustment means; and a pressure pad attached to said fine tune pressure adjustment means.

3. The framed opening bracing device of claim 1 wherein said frame attachment means is a corner support unit and further comprises a pivotal connection member and an angled bracket, said pivotal connection member being attached to said angled bracket.

4. The framed opening bracing device of claim 1 wherein the relative distance adjustment means of the support arm is a telescoping tube comprising a plurality of tube segments serially attached to each other for relatively adjusting the plumb of the framed opening and the fine tune micro-distance adjustment means is a turnbuckle for micrometerly adjusting the plumb of the framed opening.

5. The framed opening bracing device of claim 4 wherein the relative distance adjustment means further comprises a plurality of set screws for temporarily fixing said telescoping tube at a fixed distance.

6. The framed opening bracing device of claim 2 wherein the relative pressure adjustment means of the versatile clamp is a lockable sliding bar and the fine tune pressure adjustment means is a threaded rotating bolt and fitting.

7. The framed opening bracing device of claim 2 wherein the relative distance adjustment means of the support arm is a telescoping tube comprising a plurality of tube segments serially attached to each other for relatively adjusting the plumb of the framed opening and the fine tune micro-distance adjustment means is a turnbuckle for micrometerly adjusting the plumb of the framed opening.

8. The framed opening bracing device of claim 7 wherein the relative distance adjustment means further comprises a plurality of set screws for temporarily fixing said telescoping tube at a fixed distance.

9. The framed opening bracing device of claim 3 wherein the relative distance adjustment means of the support arm is a telescoping tube comprising a plurality of tube segments serially attached to each other for relatively adjusting the plumb of the framed opening and the fine tune micro-distance adjustment means is a turnbuckle for micrometerly adjusting the plumb of the framed opening.

10. The framed opening bracing device of claim 9 wherein the relative distance adjustment means further comprises a plurality of set screws for temporarily fixing said telescoping tube at a fixed distance.

11. A framed opening bracing kit comprising:
a plurality of support members, each of said support members further comprising:
a support arm, said support arm further comprising a relative distance adjustment means and a fine tune distance micro-adjustment means each fixedly attached in series; and
a fixable base pivotally attached to said support arm, said fixable base further comprising a planar plate having a multitude of holes extending through the planar plate for securing the fixable base to a flooring substrate; and
a versatile clamp attachment means, removably and pivotally attached to said support member, comprising:
a pivotal connection member;
a relative pressure adjustment means fixedly attached to said pivotal connection member;
a fixed stop attached to said relative pressure adjustment means;
a fine tune pressure adjustment means attached to said relative pressure adjustment means; and
a pressure pad attached to said fine tune pressure adjustment means; and
a corner support attachment means, removably and pivotally attached to said support member, comprising a pivotal connection member and an angled bracket.

12. The framed opening bracing kit of claim 11 wherein the relative distance adjustment means of the support arm is a telescoping tube comprising a plurality of tube segments for relatively adjusting the plumb of the framed opening and the fine tune micro-distance adjustment means is a turnbuckle for micrometerly adjusting the plumb of the framed opening.

13. The framed opening bracing kit of claim 12 wherein the relative distance adjustment means further comprises a plurality of set screws for temporarily fixing said telescoping tube at a fixed distance.

14. The framed opening bracing kit of claim 11 wherein the relative pressure adjustment means of the versatile clamp attachment means is a lockable sliding bar and the fine tune pressure adjustment means is a threaded rotating bolt and fitting.

15. A framed opening bracing kit comprising: a planar plate having a multitude of holes; a support arm connector member fixedly attached to said planar plate; a base connector member removably attached to said planar plate; a first support arm segment fixedly connected to said base connector member; a second support arm segment telescopically connected to said first support arm segment; a pair of set screws removable connected to said first support arm segment and said second support arm segment for fixing the position of the second support arm with respect to the second support arm; a turnbuckle fixedly connected to said second support arm segment for fine tuning; a frame attachment connector member fixedly attached to said turnbuckle; and a frame attachment means, said frame attachment means further comprising a pivotal connection member fixedly attached to the frame attachment connector member.

16. The framed opening bracing kit of claim 15 wherein said frame attachment means is a versatile clamp and further comprises: a lockable sliding bar fixedly attached to said pivotal connection member for relatively adjusting the pressure applied to a framed opening; a fixed stop attached to said lockable sliding bar; a threaded fitting attached to said lockable sliding bar; a threaded rotating bolt meshing with said threaded fitting for fine tuning pressure applied to the framed opening; and a pressure pad attached to said threaded rotating bolt.

17. The framed opening bracing kit of claim 15 wherein said frame attachment means is a corner support unit further comprising an angled bracket.

18. The framed opening bracing kit of claim 15 further comprising a multitude of floor connecting implements for attaching said planar plate to a horizontal floor.

19. The framed opening bracing kit of claim 15 further comprising a plurality of cement blocks for attaching said planar plate to a horizontal floor.

20. The framed opening bracing kit of claim 15 wherein said multitude of floor connecting implements are metal nails.
